(19) United States
(12) Patent Application Publication
(10) Pub. No.: US 2009/0111302 A1
(43) Pub. Date: Apr. 30, 2009

(54) MICROSWITCH FOR A COAXIAL PLUG AND SOCKET CONNECTOR

(76) Inventor: THOMAS ZECH, Vohreabach (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 12/256,276

(22) Filed: Oct. 22, 2008

(30) Foreign Application Priority Data
Oct. 24, 2007 (DE) 10 2007 051 101.1

(51) Int. Cl. H01R 29/00

(52) U.S. Cl. 439/188

(57) ABSTRACT

The invention concerns a microswitch for a coaxial plug and socket connector with a contact spring and a mating contact, wherein the contact spring is a cross-shaped leaf spring.

### CROSS REFERENCE TO RELATED APPLICATIONS

This application relates to and claims priority from DE 10 2007 051 101.1 filed Oct. 24, 2007, the entire contents of which are herein incorporated fully by reference.

### BACKGROUND OF THE INVENTION

1. Field of the Invention

The present invention relates to a microswitch for a coaxial plug and socket connector. More specifically, the present invention relates to a microswitch for a coaxial plug and socket connector with a contact spring and mating contact.

2. Description of the Related Art

The related art involves microswitches for coaxial connectors used, for example, in mobile telephones. Mobile telephones generally have internal antennas, but when they are inserted in a vehicle's holder, for example, the mobile telephone is connected to an antenna of the vehicle. The connection of the mobile telephone to the antenna of the motor vehicle requires an interrupting of the connection to the internal antenna and a rerouting of the sending and receiving signals to and from the vehicle's antenna when the mobile telephone is inserted in the vehicle's holder. The connection to the vehicle's antenna is typically made via a coaxial cable, while the connection between coaxial cable and the mobile telephone is made via a coaxial plug and socket connector.

An alternative use of such microswitches is as a test switch for the testing of a surface-mounted circuit board.

A coaxial plug and socket connector with a switching function in which the inserting of a coaxial connector into the mobile telephone automatically interrupts the contact to the internal antenna and makes the contact with an external antenna is known from DE 697 05 129 T2. The microswitch disclosed there has a contact spring and a mating contact, and when the coaxial connector is inserted an activating element interrupts the contact between the contact spring and the mating contact and makes contact with the external antenna via the coaxial connector. The contact spring here is configured as a simple leaf spring, which after the coaxial connector is released again returns the activating element to the starting position and closes the signal circuit with the internal antenna. The microswitches known from the prior art, however, have various drawbacks. For example, a simple leaf spring can only exert a relative small spring force, so that a secure closing of the contact to the internal antenna upon releasing the coaxial connector cannot always be guaranteed.

What is not appreciated by the prior art prior to the present invention is the need to provide a microswitch for a coaxial plug and socket connector that enables a secure closing of the contact with a higher spring force. Accordingly, there is a need for an improved microswitch for a coaxial plug and socket connector.

### SUMMARY OF THE INVENTION

A microswitch according to the invention for a plug and socket connector has a contact spring and a mating contact, while the contact spring is a cross-shaped leaf spring. The cross-shaped leaf spring has the advantage that a spring force is exerted not only by a lengthwise extending main bridge, but also by a cross bridge extending away from the main bridge on either side. The cross bridge is arranged ideally in a front region of the main bridge and especially in proximity to the mating contact, so that a favorable distribution of force results.

In one preferred embodiment, the cross bridge is molded onto the main bridge as a single piece. A single-piece configuration of the cross-shaped leaf spring has the advantage that the leaf spring can be produced as a punched part in a single work process and thus no extra production costs will arise.

The cross bridge can be prestressed as an arch, so that a greater spring force is achieved. Alternatively, it is also conceivable to place the ends of the cross bridge at the height of a contact surface between the contact spring and the mating contact, so that a spring force is created by a flexure of the cross bridge.

The main bridge can be bent at a right angle at one fastening end, so that a simple contacting of the contact spring from beneath and an easier mounting in the housing are possible. Likewise, the mating contact can be bent at a right angle.

In one modification of the invention, the microswitch has a housing in which an activating opening is made above a crossing point of the main bridge and the side bridge. The housing can be configured such that, when a coaxial plug is introduced into the coaxial socket, a central conductor of the coaxial plug pushes through the activating opening against the cross point of main and side bridge and thereby presses the leaf spring downward and away, releasing the connection to the mating contact. At the same time, the touching of the leaf spring by the central conductor of the coaxial plug closes a contact with an external antenna mechanism. The housing of the microswitch can be made of metal, so that an outer conductor of the coaxial plug can make contact with the ground via the housing.

In one modification of the invention, supports are provided in the housing, on which the cross bridge is floating. A floating of the cross bridge on these supports, which can be in the shape of lugs, for example, prevents the ends of the cross bridge from scraping against or getting stuck on a flat shaped base surface.

In one modification of the microswitch, the supports have different height. In this way, when the microswitch is activated, the cross bridge slides differently across the supports and the main bridge performs a slight transverse movement. This transverse movement accomplishes a slight rubbing in the contact region, which brings about a self-cleaning of the contact site.

For an especially high miniaturization, the entire microswitch can be configured as a surface mounted device (SMD), for which it is advisable to have the fastening end of the main bridge and the mating contact each be formed as a solder surface.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1, a perspective representation of a switch mechanism of a microswitch according to the invention,

FIG. 2, a perspective representation of the microswitch with housing,

FIG. 3, a transverse section through the microswitch along line A-A in FIG. 2, and

FIG. 4, a longitudinal section through the microswitch along line B-B from FIG. 2.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

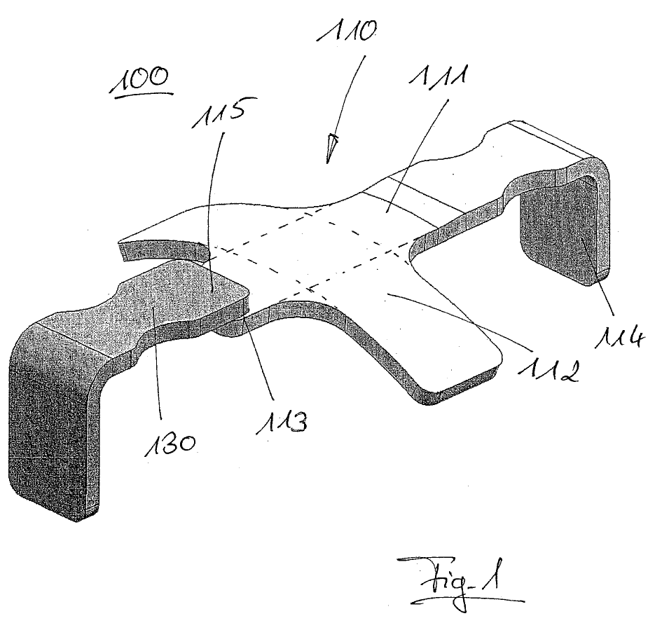

FIG. 1 shows a perspective representation of a switch mechanism 100 of a microswitch according to the invention. The switch mechanism 100 is made from a cross-shaped leaf spring 110 and a mating contact 130 of electrically conductive material. The cross-shaped leaf spring 110 has a main bridge 111 with a contact end 113 and a fastening end 114. The main bridge 111 is configured as an elongated leaf spring and it is bent at a right angle at the fastening end 114. The contact end 113 of the main bridge 111 overlaps with a mating contact 130 in a contact region 115, so that a conducting connection exists between the contact spring 110 and the mating contact 130. On the main bridge 111 of the contact spring 110, a cross bridge 112 running transversely to the main bridge 111 is molded on as a single piece. The cross bridge 112 is bent downward as an arch, so that when the cross bridge bears against a base an additional spring force is produced.

FIG. 2 shows a perspective representation of a microswitch with a housing 200 according to the invention. This housing 200 is rectangular in shape, and the base surface is roughly square shaped. A top surface of the housing 200 has a round activating opening 210 arranged in the center, lying above a crossing point of the main bridge 111 and the side bridge 112. The housing 200 has basically two parts, an outer metallic part being bent like a bracket around an inner part made of insulating material 205. The part of the housing 200 made from insulating material 205 is configured such that the switch mechanism 100 is insulated from the outer metal part and both the part of the mating contact bent at a right angle and the fastening end 114 of the leaf spring 110 bent at a right angle are led to the outside and can be used, e.g., as solder contacts.

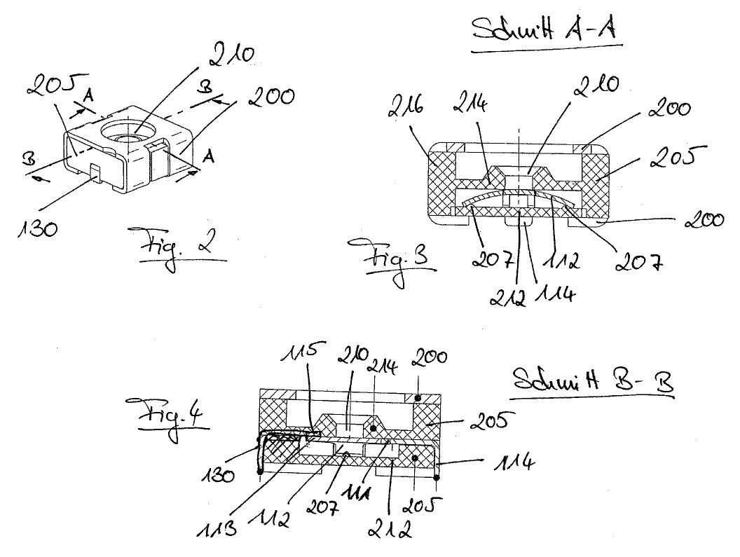

FIG. 3 shows a section through the microswitch from FIG. 2 along line A-A. The section is parallel to one side surface of the housing 200 and runs transversely to a longitudinal axis of the main bridge 111 centrally through the cross bridge 112. In this view, the configuration of the insulating material 205 inside the housing can be seen especially clearly. The insulating material forms a bottom plate 212, as well as a top plate 214 arranged parallel to the latter, through which the activating opening 210 is made at the center. The switch mechanism 100 is arranged between the bottom plate 212 and the top plate 214. The bottom plate 212 is formed separately from the side piece made of insulating material and the top plate 214 and it is installed, for example, at the end of the assembly with the switch mechanism 100. In the section view shown in FIG. 3, one clearly recognizes supports 207 formed as a single piece on the bottom plate 212, used to mount the cross bridge 112. If the lug-shaped supports 207 are made of different height, a transverse movement is induced when the switch mechanism 100 is activated through the activating opening 210, which accomplishes a self-cleaning of the contact surface between the contact spring 110 and the mating contact 130 by a rubbing in the contact region 115. The activating opening 210 is funnel-shaped in the region of the top plate 214, so that there is a centering of a centrally arranged contact pin of a coaxial plug when it is inserted.

FIG. 4 shows a longitudinal section through the microswitch of FIG. 2 along line B-B. In this view, the arrangement and fixation of the switch mechanism 100 in the part of the housing 200 made of insulating material 205 is especially well seen. The fastening end 114 of the contact spring 110, bent at a right angle, is led out from the housing 200, while the main bridge 111 is entirely surrounded by insulating material 205 in a first region and suitably mounted in a forward region so as to perform a bending movement. As was also clearly seen in FIG. 1, the mating contact 130 in the microswitch is arranged higher than the contact spring 110, so that the contact spring 110 comes to lie underneath the mating contact 130 with its contact end 113 and, in the nonactivated condition, closes the signal path between contact spring 110 and mating contact 130 with a pretensioning force.

In the application in a mobile telephone, an internal antenna of the mobile telephone is hooked up ideally to a mating contact 130 (FIG. 4), while a sending and receiving unit is hooked up at the fastening end 114 of the contact spring.

Having described at least one of the preferred embodiments of the present invention with reference to the accompanying drawings, it is to be understood that the invention is not limited to those precise embodiments, and that various changes, modifications, and adaptations maybe effected therein by one skilled in the art without departing from the scope or spirit of the invention as defined in the appended claims.

1. A microswitch for a coaxial plug and socket connector with a contact spring and a mating contact, characterized in that:
the contact spring is a cross-shaped leaf spring.

2. A microswitch, according to claim 1, wherein:
the contact spring has a main bridge with a contact end and a fastening end, and
a cross bridge extending away from the main bridge on either side.

3. A microswitch, according to claim 2, wherein:
the cross bridge is molded onto the main bridge as a single piece.

4. A microswitch, according to claim 1, wherein:
the cross bridge is prestressed as an arch.

5. A microswitch, according to claim 1, wherein:
the fastening end is bent at a right angle to said main bridge.

6. A microswitch, according to claim 2, wherein:
the mating contact is bent at a right angle relative to said main bridge.

7. A microswitch, according to claim 2, wherein:
the main bridge and the mating contact are arranged overlapping in one contact region.

8. A microswitch, according to claim 1, wherein
the microswitch has a housing, having an activating opening, which is arranged above a crossing point of the main bridge and the cross bridge.

9. A microswitch, according to claim 2, wherein:
supports are provided in a housing, on which the cross bridge is floating.

10. A microswitch, according to claim 9, wherein:
the supports are in the shape of lugs.

11. A microswitch, according to claim 9, wherein:
the supports (207) have different heights.

12. A microswitch, according to claim 8, wherein:
the housing is made of a conductive material, while the contact spring and the mating contact are arranged insulated against the housing.

13. A microswitch according to claim 2 wherein:
the fastening end and the mating contact are each formed as a solder surface.
